(19) United States
(12) Patent Application Publication
(10) Pub. No.: US 2003/0161352 A1
(43) Pub. Date: Aug. 28, 2003

(54) Service multiplexer capable of extending number of slots without increasing capacity of transmission cable

(75) Inventor: Akihiro Miyamoto, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/372,405

(22) Filed: Feb. 25, 2003

(30) Foreign Application Priority Data
Feb. 27, 2002 (JP) 2002-051284

(51) Int. Cl. H04J 3/04

(52) U.S. Cl. 370/535; 370/442

(57) ABSTRACT

A service multiplexer is disclosed for extending the number of slots without increasing the capacity of a transmission cable. Two service multiplexers are connected through a 2.4 Gbps transmission cable. Since each service multiplexer is provided with an N:1 time slot selection/distribution unit, the two service multiplexers can be connected to extend the number of slots without the need for increasing the transmission capacity from 2.4 Gbps provided by the transmission cable which connects the service multiplexers.

### BACKGROUND OF THE INVENTION

1. Field of the Invention

The present invention relates to a service multiplexer, and a service multiplexing system and method for multiplexing data from client devices such as computers into a predetermined frame such as a SONET (Synchronous Optical Network)/SDH (Synchronous Digital Hierarchy) frame or the like for transmission, and demultiplexing transmitted signals multiplexed in the predetermined frame such as the SONET/SDH frame for transmission to respective client devices associated therewith.

2. Description of the Related Art

With a rapid spread of multi-media services resulting from the popularization of the Internet in recent years, data traffic has been dramatically increased, encouraging a further acceleration in streamlining the SONET/SDH network which provides these services. The SONET/SDH network is capable of efficiently multiplexing a large number of signals for fast and long-distance transmission in accordance with an internationally standardized multiplexing grade.

FIG. 1 illustrates an exemplary system which constitutes such a SONET/SDH network. In the system illustrated in FIG. 1, two service multiplexers 10₁, 10₂ are connected through a SONET/SDH transmission path. Service multiplexers 10₁, 10₂ each multiplex data from a plurality of client devices 20₁, 20₂, respectively, into a SONET/SDH frame for transmission over the SONET/SHD transmission path, and demultiplex signals received from the SONET/SDH transmission path into respective signals for transmission to associated client devices 20₁, 20₂.

FIG. 2 illustrates the configuration of conventional service multiplexer 10₁ as mentioned above. As illustrated in FIG. 2, this conventional service multiplexer 10₁ comprises FC (Fiber Channel) multiplex/demultiplex (FC MX) card 21; GbE (Gigabit Ethernet) multiplex/demultiplex (GbE MX) card 22; OC-48 multiplex/demultiplex (OC-48 MX) card 33.

FC multiplex/demultiplex card 21 transmits data conforming to a FC protocol from an associated client device to OC-48 multiplex/demultiplex card 33 in a time slot assigned thereto, and demultiplexes data of a signal from OC-48 multiplex/demultiplex card 33 in a time slot assigned thereto to transmit the demultiplexed data to the associated client device as data conforming to the FC protocol.

OC-48 multiplex/demultiplex card 33, which functions as an SDH frame multiplex/demultiplex card, multiplexes data transmitted from FC multiplex/demultiplex card 21 and GbE multiplex/demultiplex card 33 into an SDH frame for transmission over a SONET/SDH transmission path, and receives and demultiplexes signals from the SONET/SDH transmission path for transmission to FC multiplex/demultiplex card 21 and GbE multiplex/demultiplex card 22, respectively.

FIG. 3 shows an example of assignment of time slots in an SDH frame which is transmitted from OC-48 multiplex/demultiplex card 33 over the SONET/SDH transmission path. It should be noted that the assignment of time slots shown in FIG. 3 is merely illustrative. The assignment of time slots can be changed in any way by setting them so. Also, FIG. 3 shows the assignment of time slots when they are fed into OC-48 multiplex/demultiplex card 33, wherein each service card has data only in a time slot assigned thereto. Such data are multiplexed in the SDH frame so that the SDH frame is filled with the time slots when it is fed into OC-48 multiplex/demultiplex card 33.

Service multiplexer 10₁ configured as described above can connect a client device adapted to transmit and receive data conforming to the FC protocol and a client device adapted to transmit and receive data conforming to a GbE protocol to the SONET/SDH transmission path. However, since there are client devices which can transmit and receive data conforming to a variety of protocols, the service multiplexer is connected to respective client devices through a variety of client protocols such as Gigabit Internet, Fiber Channel, ESCON, DVB-ASI, and the like. For this reason, the service multiplexer must have interfacing means suitable for a particular client device connected thereto, so that the interfacing means is provided in the form of a removable card for permitting connection of various client devices to the service multiplexer.

FIG. 4 illustrates an outer appearance of an exemplary service multiplexer. As illustrated in FIG. 4, a variety of service cards can be mounted to and used with the service multiplexer in accordance with a particular protocol used by a client device connected thereto.

Such a service multiplexer is capable of multiplexing and transmitting service data as long as the total amount of transmitted data does not exceed a maximum transmission capacity of 2.4 Gbps defined for the SONET/SDH transmission path. However, the service multiplexer cannot simultaneously use service cards beyond the number of slots provided therein for mounting service cards, for example, three slots in the service multiplexer illustrated in FIG. 4. Therefore, the service multiplexer is eventually limited in the number of multiplexed services by the number of slots even if the total transmission capacity of multiplexed services is far below 2.4 Gbps.

Services possibly used by client devices may include services which only require small capacity as well as services which require a large capacity such as Fiber Channel, Gigabit Ethernet and the like. For example, there are 100M Ethernet at 100 Mbps, 10M Ethernet at 10 Mbps, ESCON (Enterprise System Connect) at 200 Mbps, DVB (Digital Video Broadcasting) at 270 Mbps, and the like. ESCON is a registered trademark of IBM Corporation.

For multiplexing such services which only require a small capacities, a service multiplexer having a small number of slots fails to accomplish efficient transmissions because of a low degree of freedom in system design. However, a service multiplexer having an excessive number of slots would result in a prohibitively high cost and large volume, and be burdened with useless facilities if three slots are sufficient.

Thus, a need exists for extending the number of slots by combining a plurality of service multiplexers, each having more or less three slots, in the case a larger number of slots are required.

Bearing this in mind, the number of slots can be extended by connecting two service multiplexers, each of which has a limited number of slots. FIG. 5 illustrates the configuration of a service multiplexing system which extends the number of slots by connecting two conventional service multiplexers 80₁, 80₂, each of which has a limited number of slots.

The following description will be made of the assumption that each of service multiplexers 80₁, 80₂ has N slots (N is a natural number equal to or more than two, i.e., 2, 3, 4, . . . ). Service multiplexer 80₁ comprises service cards such as FC multiplex/demultiplex (FC MX) card 31₁, GbE multiplex/demultiplex (GbE MX) card 32₁, . . . , and the like which are plugged into respective slots. Service multiplexer 80₂ in turn comprises service cards such as FC multiplex/demultiplex (FC MX) card 31₂; GbE multiplex/demultiplex (GbE MX) card 32₂, . . . , and the like, as well as OC-48 multiplex/demultiplex (OC-48 MX) card 33₂, which are plugged into respective slots.

Next, FIG. 6 illustrates in block diagram the configuration of FC multiplex/demultiplex card 31₁ in FIG. 5. FC multiplex/demultiplex card 31₁ comprises FC processing unit 43 and selection/distribution unit (SEL/DIS) 42₁. FC processing unit 43 comprises optical transceiver (OPT) 51; FC frame converter (FC FRM CONV) 52; GFP frame generator (GFP) 53; and STM mapping unit (STM MP) 54. Selection/distribution unit 42₁ in turn comprises selector (SEL) 55 and distributor (DIS) 56.

Next, FIG. 7 illustrates in block diagram the configuration of GbE multiplex/demultiplex card 32₁ in FIG. 5. GbE multiplex/demultiplex card 32₁ comprises GbE processing unit 44 and selection/distribution unit (SEL/DIS) 42₂. GbE processing unit 44 comprises optical transceiver (OPT) 61; GbE MAC physical layer converter (GbE MAC PHY) 62; GFP frame generator (GFP) 63; and STM mapping unit (STM MAP) 64. Selection/Distribution unit 42₂ comprises in turn selector (SEL) 65 and distributor (DIS) 66.

Further, FIG. 8 illustrates in block diagram the configuration of OC-48 multiplex/demultiplex card 33₂ in FIG. 5. OC-48 multiplex/demultiplex card 33₂ comprises SONET processing unit 41 and N:1 time slot selection/distribution (SEL/DIS) unit 40. SONET processing unit 41 comprises optical transceiver (OPT) 71; SDH frame generator (SDH FRM) 72; and SDH frame receiver (SDH TRM) 73. N:1 time slot selection/distribution unit 40 in turn comprises N:1 time slot distributor (DIS) 45 and N:1 time slot selector (SEL) 46.

In the topology as illustrated in FIG. 5, a connection between service cards 31₁, 32₁, 31₃ and the like mounted in service multiplexer 80₁ and OC-48 multiplex/demultiplex card 33₂ mounted in service multiplexer 80₂ merely provides 2.4 Gbps/N in total. For example, when each service multiplexer has three slots, data can be transmitted at as low as 0.8 Gbps (=2.4/3) between each service card and OC-48 multiplex/demultiplex card 33₂. Thus, in the topology as illustrated in FIG. 5, data cannot be transferred at 2.4 Gbps from FC multiplex/demultiplex card 31₁ in service multiplexer 80₁ to OC-48 multiplex/demultiplex card 33₂ in service multiplexer 80₂.

The foregoing problem can be solved if the transmission capacity is increased to 2.4 Gbps×N on a transmission cable between two service multiplexers 80₁, 80₂. However, an increase in the transmission capacity of a transmission cable would result in an increase in the cost and space. In addition, such a connection is not feasible because the transmission capacity of the transmission cable must be increased as each service multiplexer has a larger number of slots.

A network topology for the SONET/SDH system can be implemented by an add/drop multiplex (ADM) ring system which is capable of high-speed and large-capacity transmission and provides flexibility. As illustrated in FIG. 9, the ADM ring system comprises a ring-shaped broadband transmission path called “ADM ring network” 90; and ADM devices 91-93 for use in extracting or adding a low-speed line from the ring-shaped broadband transmission path. Generally, ADM devices 91-93 designed to build an ADM ring system suffer from a high cost. Therefore, a system cost can be reduced if a service multiplexer can be used as an ADM device. For example, as illustrated in FIG. 9, a ADM device can be implemented at a lower cost if service multiplexer 94 composed of a plurality of service multiplexers can be connected to ADM ring network 90 as the ADM device.

FIG. 10 illustrates in block diagram the configuration of an ADM device using conventional service multiplexers 80₁, 80₂. In FIG. 10, components identical to those in FIG. 5 are designated the same reference numerals, and description thereon is omitted. It should be noted that service multiplexer 80₁ in FIG. 10 is mounted with OC-48 multiplex/demultiplex card 33₁ instead of FC multiplex/demultiplex card 31₃.

In the topology as illustrated in FIG. 10, data transmission is provided merely at 2.4 Gbps/(2N-1) through connections between service cards 31₁, 32₁ and the like mounted in service multiplexer 80₁ and OC-48 multiplex/demultiplex card 33₂ mounted in service multiplexer 80₂, through connections between service cards 31₂, 32₂ and the like mounted in service multiplexer 80₂ and OC-48 multiplex/demultiplex card 33₁ mounted in service multiplexer 80₁, and a connection between OC-48 multiplex/demultiplex card 33₁ and OC-48 multiplex/demultiplex card 33₂, respectively, as is the case with the topology illustrated in FIG. 5. For example, when each service multiplexer has five slots, data can be transmitted at as low as 0.48 Gbps (=2.4/5). Thus, in the topology as illustrated in FIG. 10, data cannot be transferred at 2.4 Gbps from FC multiplex/demultiplex card 31₁ in service multiplexer 80₁ to OC-48 multiplex/demultiplex card 33₂ in service multiplexer 80₂.

The foregoing problem can be solved similarly in this case if the transmission capacity is increased to 2.4 Gbps×(2N-1) on a transmission cable between two service multiplexers 80₁, 80₂. However, this solution is not feasible for reasons similar to the foregoing.

### SUMMARY OF THE INVENTION

It is an object of the present invention to provide a service multiplexer which can be connected in plural to extend the number of slots or create an ADM device, and a service multiplexing system and method for connecting a plurality of the service multiplexers to multiplex a larger number of services without the need for increasing the capacity of transmission cables which connect the service multiplexers.

To achieve the above object, the present invention provides a service multiplexer which is mounted with a plurality of service cards respectively supporting data protocols of a plurality of client devices for multiplexing data from the respective client devices into a predetermined frame for transmission, and for demultiplexing signals multiplexed in the predetermined frame and transmitted thereto to distribute demultiplexed signals to the client devices associated therewith. The service multiplexer includes N:1 time slot selecting/distributing means.

The N:1 time slot selecting/distributing means selects data from a total of N of service cards and a frame multiplex/demultiplex card mounted in the service multiplexer (where N is a natural number equal to or larger than two) in accordance with time slots previously assigned thereto to multiplex the data into the predetermined frame for transmission to another service multiplexer connected through a transmission cable, and for distributing data received from the other service multiplexer into the respective time slots previously assigned thereto for transmission to N of the service cards and frame multiplex/demultiplex card.

Since the service multiplexer of the present invention includes the N:1 time slot selecting/distributing means, two service multiplexers can be connected without the need for increasing the transmission capacity of the transmission cable which connects the two service multiplexers. It is therefore possible to extend the number of slots to 2N-1 beyond N-1 which can be ensured by a single service multiplexer. In addition, since an ADM device can be implemented by providing each of the two service multiplexers with an SDH frame multiplex/demultiplex card, the ADM device can be created inexpensively to reduce the cost of an ADM ring system.

Another service multiplexer according to the present invention includes N×(M-1) switching means.

The N×(M-1) switching means selects data from a total of N of service cards and a frame multiplex/demultiplex card mounted in the service multiplexer (where N is a natural number equal to or larger than two) in accordance with time slots previously assigned thereto to multiplex the data into M-1 data streams (where M is a natural number equal to or larger than two) for transmission to other M-1 service multiplexers connected through transmission cables, and for distributing M-1 data streams received from the other M-1 service multiplexers into the respective time slots previously assigned thereto for transmission to N of the service cards and frame multiplex/demultiplex card.

Since the service multiplexer of the present invention includes the N×(M-1) switching means, M service multiplexers can be connected without the need for increasing the transmission capacity of transmission cables which connect the service multiplexers. It is therefore possible to extend the number of slots to N×M-1 beyond N-1 which can be ensured by a single service multiplexer. In addition, since an ADM device can be implemented by providing two of the M service multiplexers with an SDH frame multiplex/demultiplex card, respectively, the ADM device can be created inexpensively to reduce the cost of an ADM ring system.

The present invention also provides a service multiplexing system which comprises a first and a second service multiplexer connected through a transmission cable, each of which is mounted with a plurality of service cards respectively supporting data protocols of a plurality of client devices, for multiplexing data from the respective client devices into a predetermined frame for transmission, and for demultiplexing signals multiplexed in the predetermined frame and transmitted thereto to distribute demultiplexed signals to the client devices associated therewith, wherein the first service multiplexer includes first N:1 time slot selecting/distributing means, while the second service multiplexer comprises second N:1 time slot selecting/distributing means.

The first N:1 time slot selecting/distributing means selects data from a total of N service cards mounted in the first service multiplexer (where N is a natural number equal to or larger than two) in accordance with time slots previously assigned thereto to multiplex the data into the predetermined frame for transmission to the second service multiplexer connected through the transmission cable, and for distributing data received from the second service multiplexer into the respective time slots previously assigned thereto for transmission to the N service cards.

The second N:1 time slot selecting/distributing means selects data from a total of N of service cards and a frame multiplex/demultiplex card mounted in the second service multiplexer in accordance with time slots previously assigned thereto to multiplex the data into the predetermined frame for transmission to the first service multiplexer connected through the transmission cable, and for distributing data received from the first service multiplexer into the respective time slots previously assigned thereto for transmission to N of the service cards and frame multiplex/demultiplex card.

In the service multiplexing system of the present invention, since each of the first and second service multiplexers includes the N:1 time slot selecting/distributing means, and the second service multiplexer is further mounted with the frame multiplex/demultiplex card, the two service multiplexers can be connected without the need for increasing the transmission capacity of the transmission cable which connects the two service multiplexers. It is therefore possible to extend the number of slots to 2N-1 beyond N-1 which can be ensured by a single service multiplexer.

The present invention provides another service multiplexing system which comprises a first and a second service multiplexer connected through a transmission cable, each of which is mounted with a plurality of service cards respectively supporting data protocols of a plurality of client devices, for multiplexing data from the respective client devices into a predetermined frame for transmission, and for demultiplexing signals multiplexed in the predetermined frame and transmitted thereto to distribute demultiplexed signals to the client devices associated therewith, wherein the first service multiplexer includes first N:1 time slot selecting/distributing means, while the second service multiplexer includes second N:1 time slot selecting/distributing means.

The first N:1 time slot selecting/distributing means selects data from a total of N of service cards and a frame multiplex/demultiplex card mounted in the first service multiplexer (where N is a natural number equal to or larger than two) in accordance with time slots previously assigned thereto to multiplex the data into the predetermined frame for transmission to the second service multiplexer connected through the transmission cable, and for distributing data received from the second service multiplexer into the respective time slots previously assigned thereto for transmission to N of the service cards and frame multiplex/demultiplex card.

The second N:1 time slot selecting/distributing means selects data from a total of N of service cards and a frame multiplex/demultiplex card mounted in the second service multiplexer in accordance with time slots previously assigned thereto to multiplex the data into the predetermined frame for transmission to the first service multiplexer connected through the transmission cable, and for distributing data received from the first service multiplexer into the respective time slots previously assigned thereto for transmission to N of the service cards and frame multiplex/demultiplex card.

In the service multiplexing system of the present invention, the first and second service multiplexers include the first and second N:1 time slot selecting/distributing means, respectively, and the first and second service multiplexers are further mounted with the frame multiplex/demultiplex card, respectively, so that the two service multiplexers can be connected without the need for increasing the transmission capacity of the transmission cable which connects the two service multiplexers. Consequently, an ADM device can be implemented inexpensively to reduce the cost of an ADM ring system.

The present invention further provides a service multiplexing system which comprises a plurality of service multiplexers connected through transmission cables, each of which is mounted with a plurality of service cards respectively supporting data protocols of a plurality of client devices, for multiplexing data from the respective client devices into a predetermined frame for transmission, and for demultiplexing signals multiplexed in the predetermined frame and transmitted thereto to distribute demultiplexed signals to the client devices associated therewith, wherein at least one of the plurality of service multiplexers includes first N×(M-1) switching means, while each of the remaining service multiplexers of the plurality of service multiplexers includes second N×(M-1) switching means.

The first N×(M-1) switching means selects data from a total of N of service cards and a frame multiplex/demultiplex card mounted in the service multiplexer (where N is a natural number equal to or larger than two) in accordance with time slots previously assigned thereto to multiplex the data into the predetermined frame for transmission to the other service multiplexers connected through the transmission cables, and for distributing data received from the other service multiplexers into the respective time slots previously assigned thereto for transmission to N of the service cards and frame multiplex/demultiplex card.

The second N×(M-1) switching means selects data from a total of N service cards mounted in the service multiplexer in accordance with time slots previously assigned thereto to multiplex the data into the predetermined frame for transmission to the other service multiplexers connected through the transmission cables, and for distributing data received from the other service multiplexers into the respective time slots previously assigned thereto for transmission to the N service cards.

In the service multiplexing system of the present invention, each of the service multiplexers includes the first or second N×(M-1) switching means, and at least one service multiplexer is further mounted with the frame multiplex/demultiplex card, so that M service multiplexers can be connected without the need for increasing the transmission capacity of the transmission cables which connect the M service multiplexers. It is therefore possible to extend the number of slots to N×M-1 beyond N-1 which can be ensured by a single service multiplexer.

The present invention further provides a service multiplexing system which comprises a plurality of service multiplexers connected through transmission cables, each of which is mounted with a plurality of service cards respectively supporting data protocols of a plurality of client devices, for multiplexing data from the respective client devices into a predetermined frame for transmission, and for demultiplexing signals multiplexed in the predetermined frame and transmitted thereto to distribute demultiplexed signals to the client devices associated therewith, wherein at least two of the plurality of service multiplexers include first N×(M-1) switching means, while the remaining service multiplexers of the plurality of service multiplexers each comprise second N×(M-1) switching means.

The first N×(M-1) switching means selects data from a total of N of service cards and a frame multiplex/demultiplex card mounted in the respective service multiplexer (where N is a natural number equal to or larger than two) in accordance with time slots previously assigned thereto to multiplex the data into the predetermined frame for transmission to the other service multiplexers connected through the transmission cables, and for distributing data received from the other service multiplexers into the respective time slots previously assigned thereto for transmission to N of the service cards and frame multiplex/demultiplex card.

The second N×(M-1) switching means selects data from a total of N service cards mounted in the service multiplexer in accordance with time slots previously assigned thereto to multiplex the data into the predetermined frame for transmission to the other service multiplexers connected through the transmission cables, and for distributing data received from the other service multiplexers into the respective time slots previously assigned thereto for transmission to the N service cards.

In the service multiplexing system of the present invention, each of the service multiplexers includes the first or second N:1 time slot selecting/distributing means, and at least two service multiplexers are further mounted with the frame multiplex/demultiplex card, respectively, so that M service multiplexers can be connected without the need for increasing the transmission capacity of the transmission cables which connects the M service multiplexers. Consequently, an ADM device can be implemented inexpensively to reduce the cost of an ADM ring system.

The predetermined frame may be an SDH frame, while the frame multiplex/demultiplex card may be an OC-48 multiplex/demultiplex card.

The above and other objects, features and advantages of the present invention will become apparent from the following description with reference to the accompanying drawings which illustrate examples of the present invention.

### BRIEF DESCRIPTION OF THE DRAWINGS

FIG. 1 is a diagram illustrating an exemplary system which constitutes a SONET/SDH network;

FIG. 2 is a block diagram illustrating the configuration of conventional service multiplexer 10₁;

FIG. 3 is a diagram showing assignment of time slots in an SDH frame;

FIG. 4 is a perspective view illustrating an outer appearance of the service multiplexer;

FIG. 5 is a block diagram illustrating the configuration of two conventional service multiplexers 80₁, 80₂ which are connected to extend the number of slots;

FIG. 6 is a block diagram illustrating an FC multiplex/demultiplex card 31₁ in FIG. 5;

FIG. 7 is a block diagram illustrating a GbE multiplex/demultiplex card 32₁ in FIG. 5;

FIG. 8 is a block diagram illustrating an OC-48 multiplex/demultiplex card 33₂ in FIG. 5;

FIG. 9 is a diagram illustrating the configuration of an ADM ring;

FIG. 10 is a block diagram illustrating the configuration of an ADM device composed of two conventional service multiplexers 80₁, 80₂ connected to each other;

FIG. 11 is a block diagram illustrating the configuration of a service multiplexer according to a first embodiment of the present invention;

FIG. 12 is a block diagram illustrating how a system is implemented using the service multiplexer according to the first embodiment of the present invention;

FIG. 13 is a block diagram illustrating the configuration of a service multiplexer according to a second embodiment of the present invention;

FIG. 14 is a block diagram illustrating how a system is implemented using the service multiplexer according to the second embodiment of the present invention; and

FIG. 15 is a block diagram illustrating the configuration of a service multiplexer according to a third embodiment of the present invention.

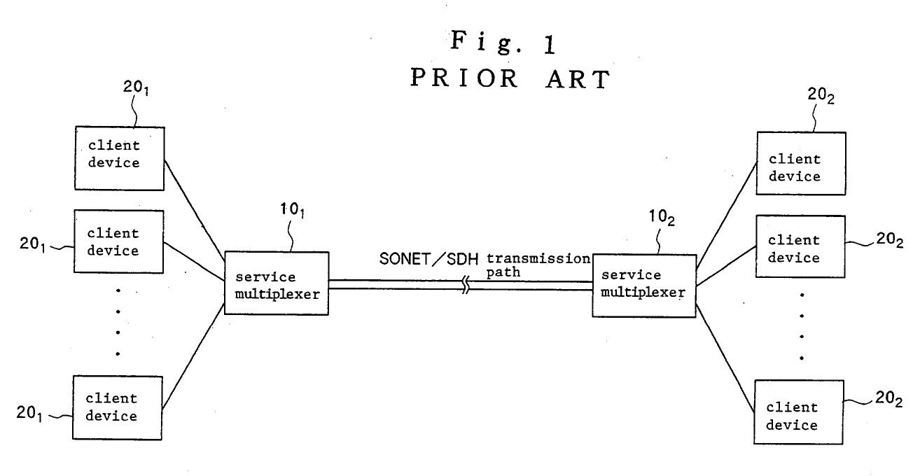

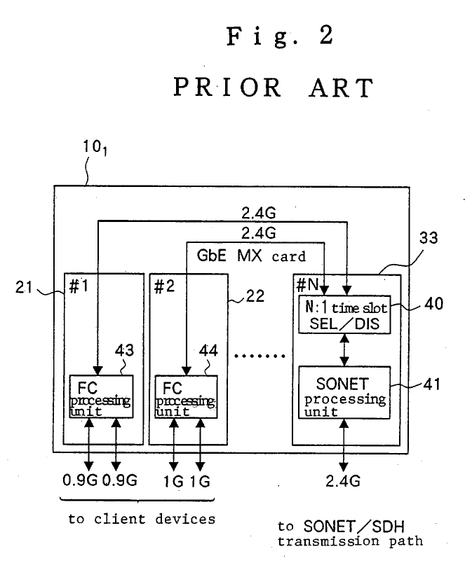

### DETAILED DESCRIPTION OF THE PREFERRED EMBODIMENTS

First Embodiment

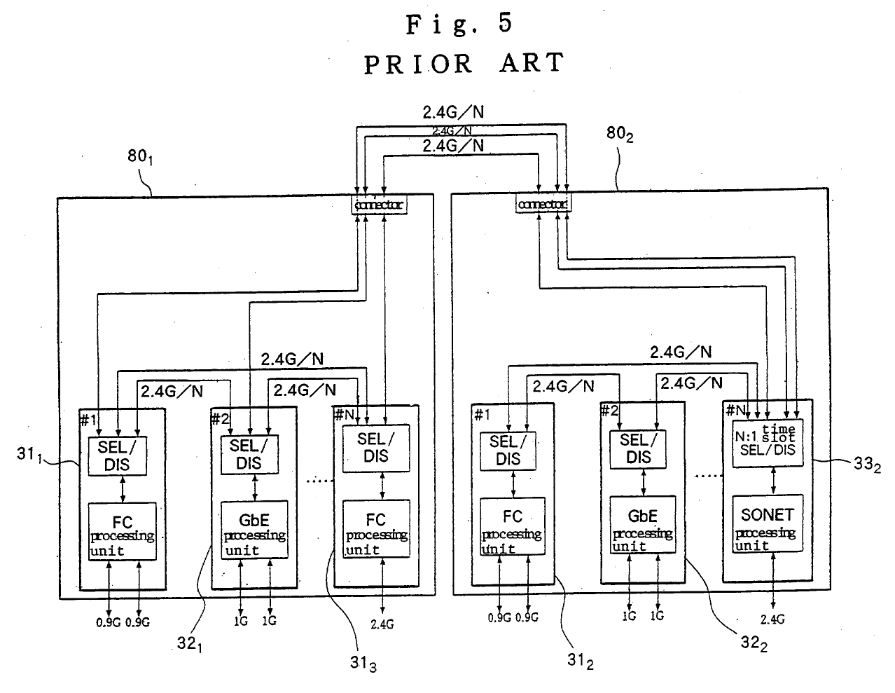

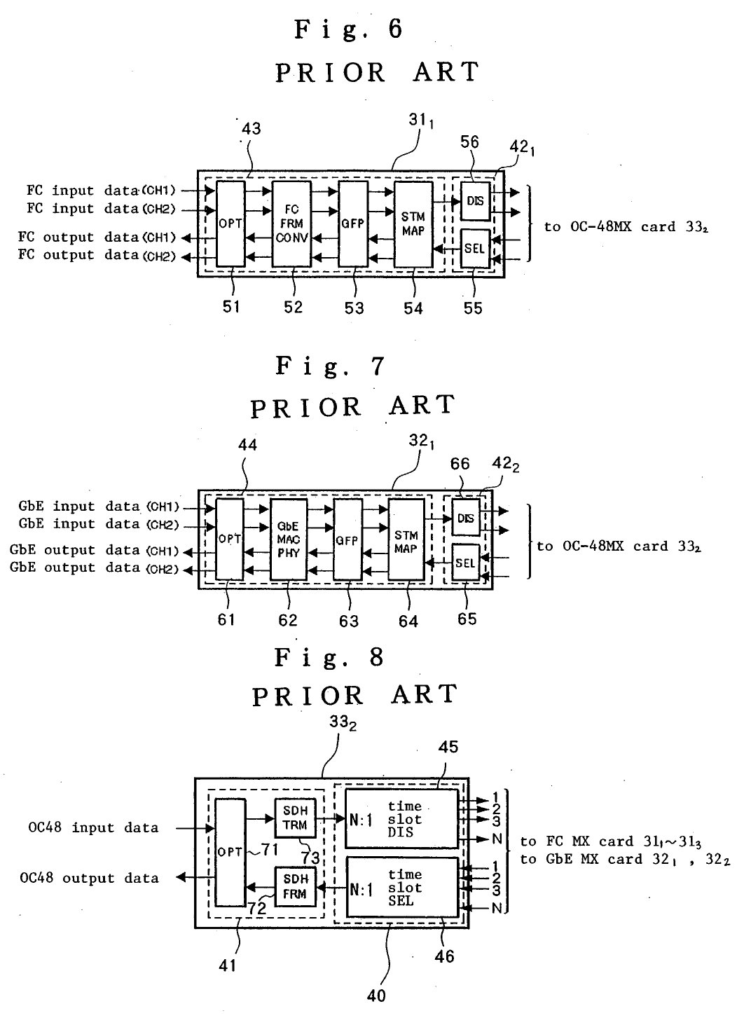

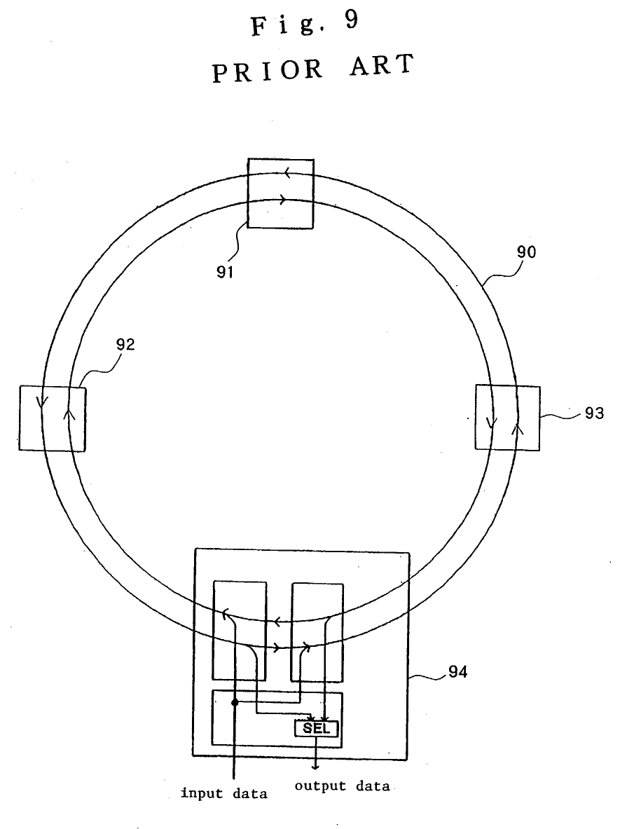

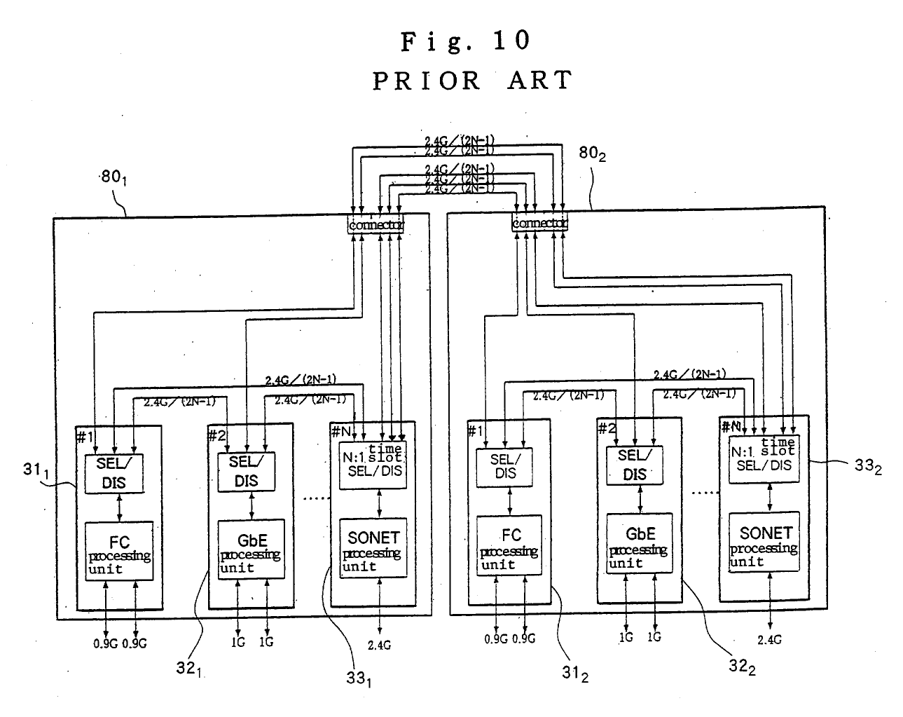

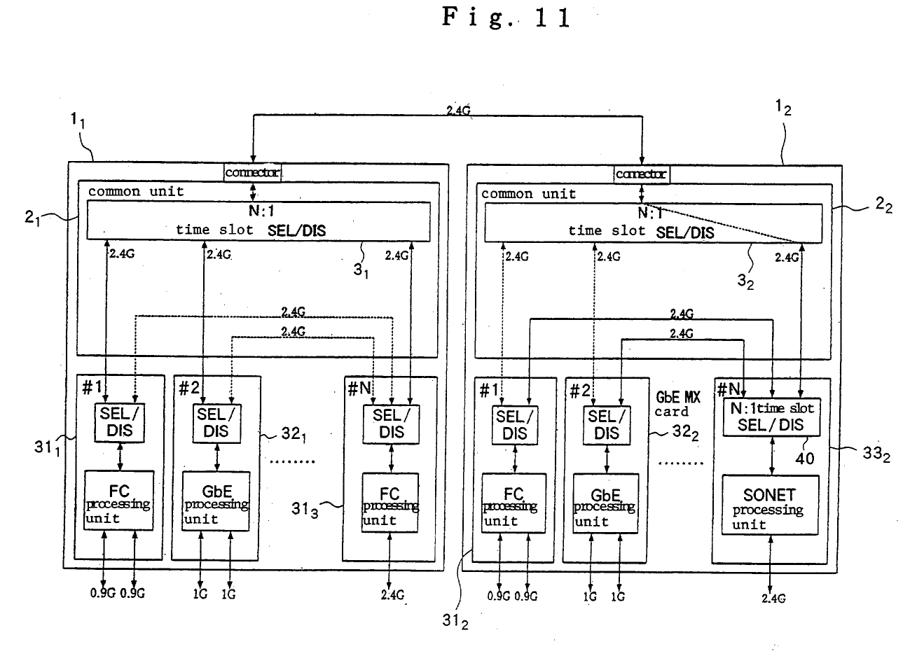

FIG. 11 is a block diagram illustrating the configuration of a service multiplexing system according to a first embodiment of the present invention. In FIG. 11, components identical to those in FIG. 5 are designated the same reference numerals, and description thereon is omitted.

In FIG. 11, the service multiplexing system according to the first embodiment has two service multiplexers 1₁, 1₂ connected through a transmission cable having a capacity of 2.4 Gbps.

As illustrated in FIG. 11, service multiplexer 1₁ has common unit 2₁ added to conventional service multiplexer 80₁ illustrated in FIG. 5. Likewise, service multiplexer 1₂ has common unit 2₂ added to conventional service multiplexer 80₂ illustrated in FIG. 5. Common unit 2₁ comprises N:1 time slot selection/distribution unit (SEL/DIS) 31. Likewise, common unit 2₂ comprises N:1 time slot selection/distribution unit (SEL/DIS) 3₂. Here, N is a natural number equal to or larger than two, i.e., 2, 3, 4, . . . .

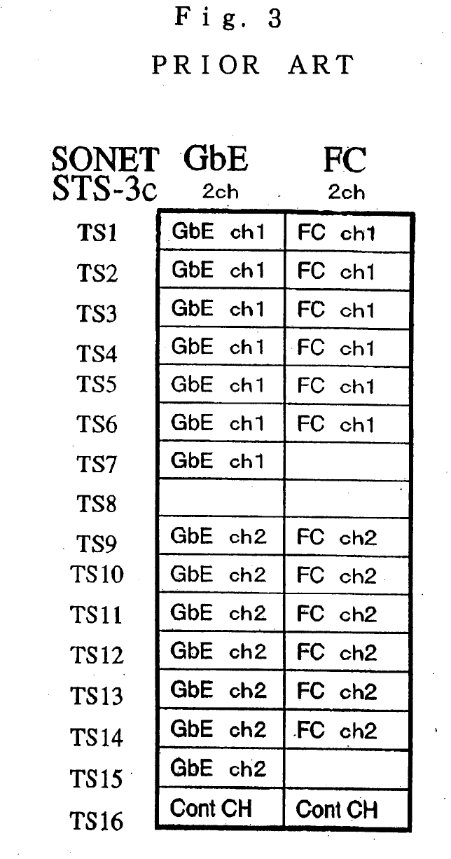

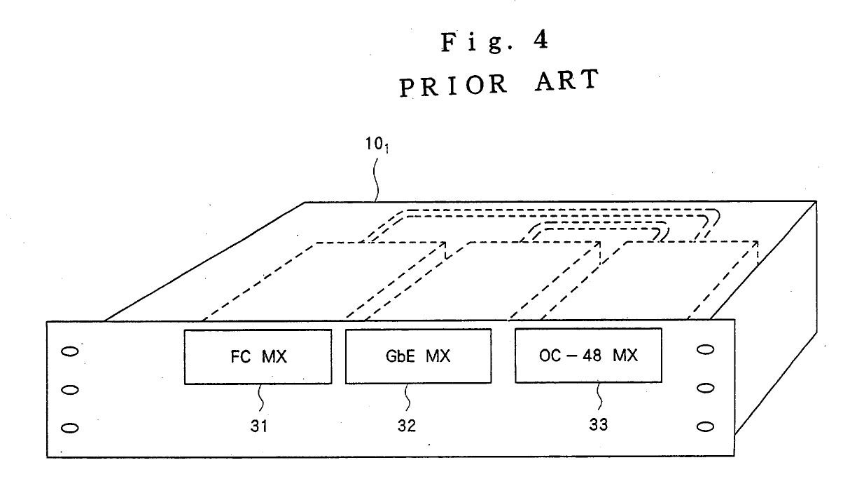

N:1 time slot selection/distribution units 3₁, 3₂, each of which is similar in configuration to N:1 time slot selection/distribution unit 40 disposed on OC-48 multiplex/demultiplex card 33₂ and the like, multiplex data from connected service cards, OC-48 multiplex/demultiplex card and the like in time slots assigned, for example, as shown in FIG. 3, to format data at 2.4 Gbps. Also, N:1 time slot selection/distribution 3₁, 3₂ each distribute data to which time slots have been assigned as shown in FIG. 3, for transmission to associated service cards and OC-48 multiplex/demultiplex card.

N:1 time slot selection/distribution unit 3₁ selects data from FC multiplex/demultiplex cards 31₁, 31₃ and GbE multiplex/demultiplex card 32₁ in accordance with time slots previously assigned thereto for multiplexing into data at 2.4 Gbps which is transmitted to service multiplexer 1₂, and distributes data at 2.4 Gbps received from service multiplexer 1₂ into respective time slots previously assigned thereto for transmission to FC multiplex/demultiplex cards 31₁, 31₃ and GbE multiplex/demultiplex card 32₁, respectively.

N:1 time slot selection/distribution unit 3₂ selects data from FC multiplex/demultiplex cards 31₂, GbE multiplex/demultiplex card 32₂ and OC-48 multiplex/demultiplex card 33₂ in accordance with time slots previously assigned thereto for multiplexing into data at 2.4 Gbps which is transmitted to service multiplexer 1₁, and distributes data at 2.4 Gbps received from service multiplexer 1₁ into respective time slots previously assigned thereto for transmission to FC multiplex/demultiplex cards 31₂, GbE multiplex/demultiplex card 32₂ and OC-48 multiplex/demultiplex card 33₂, respectively.

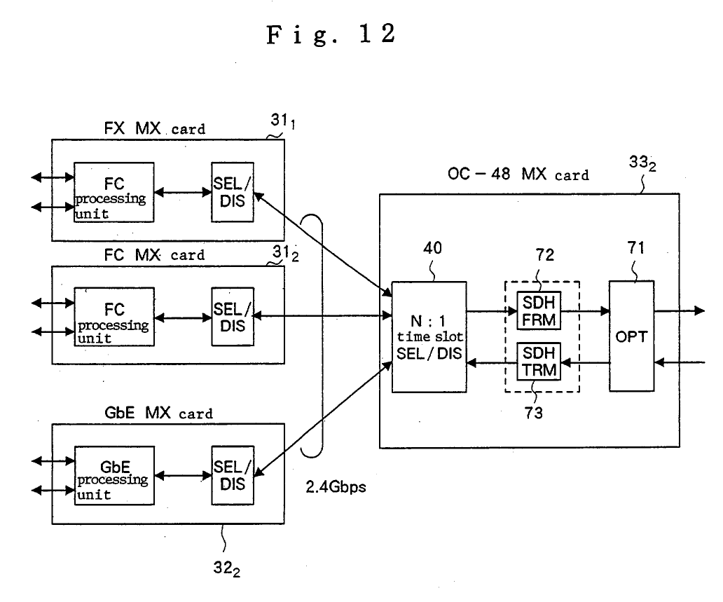

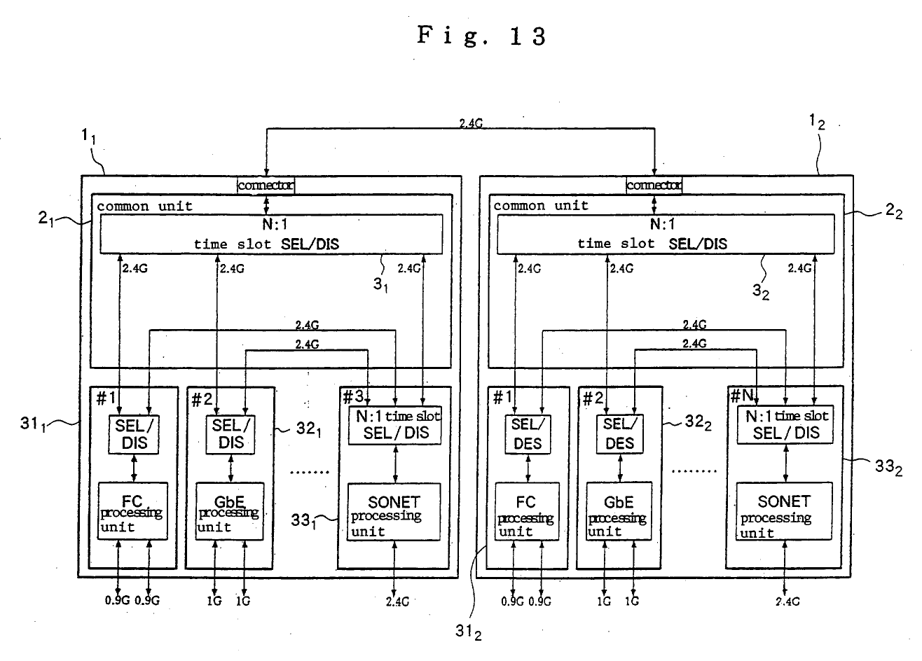

FIG. 12 illustrates how a system is implemented using the service multiplexer according to the first embodiment. As illustrated in FIG. 12, according to the first embodiment, all service cards mounted in service multiplexers 1₁, 1₂ such as OC-48 multiplex/demultiplex card 33₂, FC multiplex/demultiplex cards 31₁, 31₂, . . . , GbE multiplex/demultiplex cards 32₁, 32₂, . . . , and the like are connected over a 2.4-Gbps transmission path through N:1 time slot selection/distribution units 3₁, 3₂.

According to the first embodiment, since connected service multiplexers 1₁, 1₂ comprise N:1 time slot selection/distribution units 3₁, 3₂, respectively, the number of slots can be increased by connecting two service multiplexers 1₁, 1₂ without the need for increasing the transmission capacity from 2.4 Gbps provided by a transmission cable which connects between service multiplexers 1₁, 1₂.

A conventional service multiplexer can use only N-1 slots for mounting service cards, except for one which is plugged with an OC-48 multiplex/demultiplex card, where N is the number of slots provided in each service multiplexer. In contrast, the service multiplexer according to the first embodiment can use 2N-1 slots for mounting service cards.

Second Embodiment

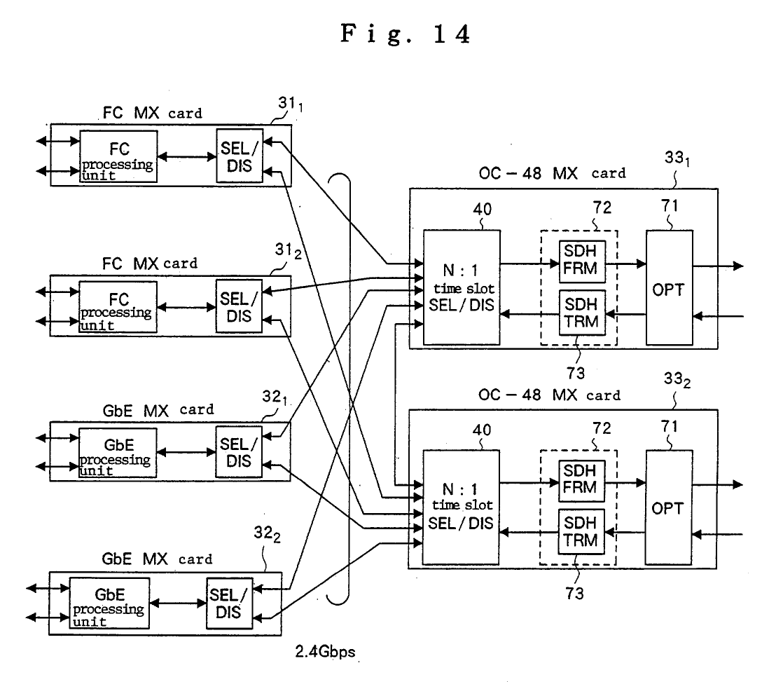

Next, description will be made on a service multiplexer according to a second embodiment of the present invention. FIG. 13 is a block diagram illustrating the configuration of the service multiplexer according to the second embodiment of the present invention. In FIG. 13, components identical to those in FIG. 11 are designated the same reference numerals, and description thereon is omitted.

In the second embodiment, an ADM device is composed of two service multiplexers 1₁, 1₂. Service multiplexer 1₁ in the second embodiment comprises OC-48 multiplex/demultiplex card 33₁ instead of FC multiplex/demultiplex card 31₃ in FIG. 11.

FIG. 14 illustrates how a system is implemented using the service multiplexer according to the second embodiment. As illustrated in FIG. 14, according to the second embodiment, OC-48 multiplex/demultiplex cards 33₁, 33₂ are connected to all service cards mounted in service multiplexers 1₁, 1₂ such as FC multiplex/demultiplex cards 31₁, 31₂, . . . , GbE multiplex/demultiplex cards 32₁, 32₂, . . . , and the like through respective N:1 time slot selection/distribution units 40 over a 2.4-Gbps transmission path.

In the configuration of the ADM device illustrated in FIG. 14, it seems that a transmission capacity of 2.4×2 Gbps is apparently required between two service multiplexers 1₁, 1₂ when referring only to the wiring. However, since the assignment of time slots has been defined by SDH in transmission/reception at the same slot to ensure that time slots added (inserted) to a slot are dropped (branched) from the same slot in the same quantity, the transmission capacity of 2.4 Gbps is sufficient between two service multiplexers 2₁, 2₂.

According to the second embodiment, since connected service multiplexers 1₁, 1₂ comprise N:1 time slot selection/distribution units 3₁, 3₂, respectively, the ADM device can be implemented by connecting two service multiplexers 1₁, 1₂ without the need for increasing the transmission capacity from 2.4 Gbps provided by a transmission cable which connects between service multiplexers 1₁, 1₂. Thus, the ADM device can be implemented inexpensively to reduce the cost of an ADM ring system.

The ADM device composed of the service multiplexers according to the second embodiment can use 2N-2 slots for mounting service cards, where N is the number of slots provided in each service multiplexer.

Third Embodiment

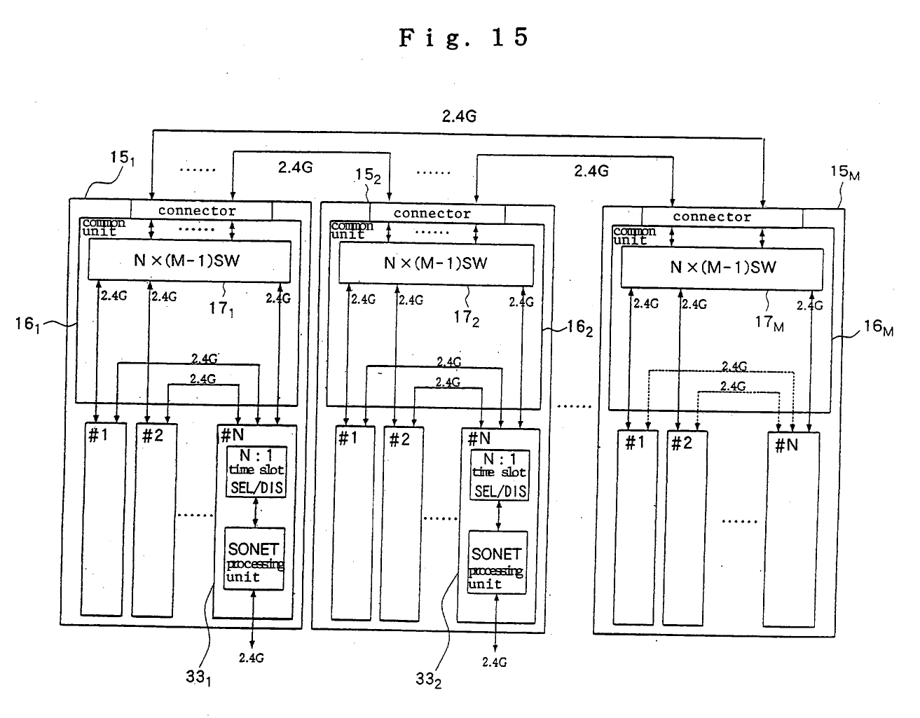

Next, description will be made on a service multiplexer according to a third embodiment of the present invention. FIG. 15 is a block diagram illustrating the configuration of the service multiplexer according to the third embodiment of the present invention. In FIG. 15, components identical to those in FIGS. 11 and 13 are designated the same reference numerals, and description thereon is omitted.

While the second embodiment uses two service multiplexers 1₁, 1₂ to build an ADM device, the third embodiment uses M service multiplexers 15₁-15_{M} (where M is a natural number equal to or larger than two, i.e., 2, 3, 4, . . . ) to build an ADM device.

Service multiplexer 15₁ comprises N-1 service cards; OC-48 multiplex/demultiplex card 33₁; and common unit 16₁. Common unit 16₁ comprises N×(M-1) switch (N×(M-1) SW) 17₁. Likewise, service multiplexer 15₂ comprises N-1 service cards; OC-48 multiplex/demultiplex card 33₂; and common unit 16₂. Common unit 16₂ comprises N×(M-1) switch (N×(M-1) SW) 17₂.

Further, remaining service multiplexers 15₃-15_{M} comprise N service cards and common units 16₃-16_{M}, respectively. Common unit 16₃-16_{M} comprise switches 17₃-17_{M}, respectively.

N×(M-1) switch 17₁, which functions as N×(M-1) switching means, selects data from N service cards and OC-48 multiplex/demultiplex card 33₁ mounted in service multiplexer 1₁, respectively, in accordance with time slots previously assigned thereto for multiplexing into M-1 data streams at 2.4 Gbps which are transmitted to M-1 remaining service multiplexers 15₂-15_{M}, and distributes M-1 data streams at 2.4 Gbps received from M-1 remaining service multiplexers 15₂-15_{M} into time slots previously assigned thereto for transmission to N service cards and OC-48 multiplex/demultiplex card 33₁ mounted in service multiplexer 1₁. In other words, N×(M-1) switch 17₁ has a configuration just like a collection of M-1 N:1 time slot selection distribution units 3₁ illustrated in FIG. 11.

Since N×(M-1) switches 17₂-17_{M} are each configured and operate in a similar manner to N×(M-1) switch 17₁, description thereon is omitted.

According to the third embodiment, since respective service multiplexers 15₁-15_{M} comprise N(M-1) switches 17₁-17_{M}, respectively, M service multiplexers 15₁-15_{M} can be connected without the need for increasing the transmission capacity from 2.4 Gbps provided by transmission cables which connect between the respective service multiplexers.

The ADM device implemented according to the third embodiment can use service cards plugged into N×M-2 slots out of the total number N×M of slots provided by the M service multiplexers except for those slots which are plugged with OC-48 multiplex/demultiplex cards 33₁, 33₂.

In the third embodiment which uses M service multiplexers 15₁-15_{M} to implement an ADM device, M service multiplexers 15₁-15_{M} may be connected to one another, with an OC-48 multiplex/demultiplex card mounted only in one of the service multiplexers, wherein a resulting service multiplexing system can extend up to M×N-1 slots which are available for connecting service cards.

The foregoing first to third embodiments have been described in connection which FC multiplex/demultiplex cards 31₁- 31₃, GbE multiplex/demultiplex cards 32₁, 32₂, and the like, taken as examples of service cards which support data protocols of client devices, the service multiplexer can be mounted with various service cards which support data protocols of client devices, other than the foregoing service cards, for connection with a variety of client devices.

While preferred embodiments of the present invention have been described using specific terms, such description is for illustrative purposes only, and it is to be understood that changes and variations may be made without departing from the spirit or scope of the following claims.

What is claimed is:

1. A service multiplexer mounted with a plurality of service cards respectively supporting data protocols of a plurality of client devices for multiplexing data from said respective client devices into a predetermined frame for transmission, and for demultiplexing signals multiplexed in the predetermined frame and transmitted thereto to distribute demultiplexed signals to said client devices associated therewith, said service multiplexer comprising:
N:1 time slot selecting/distributing means for selecting data from a total of N of service cards and a frame multiplex/demultiplex card mounted in said service multiplexer (where N is a natural number equal to or larger than two) in accordance with time slots previously assigned thereto to multiplex the data into the predetermined frame for transmission to another service multiplexer through a transmission cable, and for distributing data received from said other service multiplexer into the respective time slots previously assigned thereto for transmission to N of said service cards and said frame multiplex/demultiplex card.

2. A service multiplexer mounted with a plurality of service cards respectively supporting data protocols of a plurality of client devices for multiplexing data from said respective client devices into a predetermined frame for transmission, and for demultiplexing signals multiplexed in the predetermined frame and transmitted thereto to distribute demultiplexed signals to said client devices associated therewith, said service multiplexer comprising:
N×(M-1) switching means for selecting data from a total of N of service cards and a frame multiplex/demultiplex card mounted in said service multiplexer (where N is a natural number equal to or larger than two) in accordance with time slots previously assigned thereto to multiplex the data into M-1 data streams (where M is a natural number equal to or larger than two) for transmission to other M-1 service multiplexers through transmission cables, and for distributing M-1 data streams received from said other M-1 service multiplexers into the respective time slots previously assigned thereto for transmission to N of said service cards and said frame multiplex/demultiplex card.

3. The service multiplexer according to claim 1, wherein said predetermined frame is an SDH frame.

4. The service multiplexer according to claim 1, wherein said frame multiplex/demultiplex card is an OC-48 multiplex/demultiplex card.

5. A service multiplexing system comprising a-first and a second service multiplexer connected through a transmission cable, said first and second service multiplexers each mounted with a plurality of service cards respectively supporting data protocols of a plurality of client devices for multiplexing data from said respective client devices into a predetermined frame for transmission, and for demultiplexing signals multiplexed in the predetermined frame and transmitted thereto to distribute demultiplexed signals to said client devices associated therewith, wherein:
said first service multiplexer comprises first N:1 time slot selecting/distributing means for selecting data from a total of N service cards mounted in said first service multiplexer (where N is a natural number equal to or larger than two) in accordance with time slots previously assigned thereto to multiplex the data into the predetermined frame for transmission to said second service multiplexer connected through the transmission cable, and for distributing data received from said second service multiplexer into the respective time slots previously assigned thereto for transmission to said N service cards; and
said second service multiplexer comprises second N:1 time slot selecting/distributing means for selecting data from a total of N of service cards and a frame multiplex/demultiplex card mounted in said second service multiplexer in accordance with time slots previously assigned thereto to multiplex the data into the predetermined frame for transmission to said first service multiplexer connected through the transmission cable, and for distributing data received from said first service multiplexer into the respective time slots previously assigned thereto for transmission to N of said service cards and said frame multiplex/demultiplex card.

6. A service multiplexing system comprising a first and a second service multiplexer connected through a transmission cable, said first and second service multiplexers each mounted with a plurality of service cards respectively supporting data protocols of a plurality of client devices for multiplexing data from said respective client devices into a predetermined frame for transmission, and for demultiplexing signals multiplexed in the predetermined frame and transmitted thereto to distribute demultiplexed signals to said client devices associated therewith, wherein:
said first service multiplexer comprises first N:1 time slot selecting/distributing means for selecting data from a total of N of service cards and a frame multiplex/demultiplex card mounted in said first service multiplexer (where N is a natural number equal to or larger than two) in accordance with time slots previously assigned thereto to multiplex the data into the predetermined frame for transmission to said second service multiplexer connected through the transmission cable, and for distributing data received from said second service multiplexer into the respective time slots previously assigned thereto for transmission to N of said service cards and said frame multiplex/demultiplex card; and
said second service multiplexer comprises second N:1 time slot selecting/distributing means for selecting data from a total of N of service cards and a frame multiplex/demultiplex card mounted in said second service multiplexer in accordance with time slots previously assigned thereto to multiplex the data into the predetermined frame for transmission to said first service multiplexer connected through the transmission cable, and for distributing data received from said first service multiplexer into the respective time slots previously assigned thereto for transmission to N of said service cards and said frame multiplex/demultiplex card.

7. A service multiplexing system comprising a plurality of service multiplexers connected through transmission cables, said service multiplexers each mounted with a plurality of service cards respectively supporting data protocols of a plurality of client devices for multiplexing data from said respective client devices into a predetermined frame for transmission, and for demultiplexing signals multiplexed in the predetermined frame and transmitted thereto to distribute demultiplexed signals to said client devices associated therewith, wherein:
at least one of said plurality of service multiplexers comprises first N×(M-1) switching means for selecting data from a total of N of service cards and a frame multiplex/demultiplex card mounted in said service multiplexer (where N is a natural number equal to or larger than two) in accordance with time slots previously assigned thereto to multiplex the data into the predetermined frame for transmission to the other service multiplexers connected through the transmission cables, and for distributing data received from said other service multiplexers into the respective time slots previously assigned thereto for transmission to N of said service cards and said frame multiplex/demultiplex card; and
the remaining service multiplexers of said plurality of service multiplexers each comprise second N×(M-1) switching means for selecting data from a total of N service cards mounted in said service multiplexer in accordance with time slots previously assigned thereto to multiplex the data into the predetermined frame for transmission to the other service multiplexers connected through the transmission cables, and for distributing data received from said other service multiplexers into the respective time slots previously assigned thereto for transmission to said N service cards.

8. A service multiplexing system comprising a plurality of service multiplexers connected through transmission cables, said service multiplexers each mounted with a plurality of service cards respectively supporting data protocols of a plurality of client devices for multiplexing data from said respective client devices into a predetermined frame for transmission, and for demultiplexing signals multiplexed in the predetermined frame and transmitted thereto to distribute demultiplexed signals to said client devices associated therewith, wherein:
at least two of said plurality of service multiplexers each comprise first N×(M-1) switching means for selecting data from a total of N of service cards and a frame multiplex/demultiplex card mounted in said respective service multiplexer (where N is a natural number equal to or larger than two) in accordance with time slots previously assigned thereto to multiplex the data into the predetermined frame for transmission to the other service multiplexers connected through the transmission cables, and for distributing data received from said other service multiplexers into the respective time slots previously assigned thereto for transmission to N of said service cards and said frame multiplex/demultiplex card; and
the remaining service multiplexers of said plurality of service multiplexers each comprise second N×(M-1) switching means for selecting data from a total of N service cards mounted in said service multiplexer in accordance with time slots previously assigned thereto to multiplex the data into the predetermined frame for transmission to the other service multiplexers connected through the transmission cables, and for distributing data received from said other service multiplexers into the respective time slots previously assigned thereto for transmission to said N service cards.

9. The service multiplexing system according to claim 5, wherein said predetermined frame is an SDH frame.

10. The service multiplexing system according to claim 5, wherein said frame multiplex/demultiplex card is an OC-48 multiplex/demultiplex card.

11. A service multiplexing method for multiplexing data from a plurality of client devices conforming to different data protocols into a predetermined frame for transmission, and for demultiplexing transmitted signals multiplexed in the predetermined frame for transmission to said client devices associated therewith, said method comprising the steps of:
selecting data from a total of N of service cards and a frame multiplex/demultiplex card mounted in one of two service multiplexers connected through a transmission cable (where N is a natural number equal to or larger than two) in accordance with time slots previously assigned thereto to multiplex the data into the predetermined frame for transmission to the other service multiplexer connected through the transmission cable; and
distributing data received from the other one of said two service multiplexers into the respective time slots previously assigned thereto to transmit the data to N of said service cards and said frame multiplex/demultiplex card, respectively, mounted in said one service multiplexer.

12. A service multiplexing method for multiplexing data from a plurality of client devices conforming to different data protocols into a predetermined frame for transmission, and for demultiplexing transmitted signals multiplexed in the predetermined frame to said each client device, said method comprising the steps of:
selecting data from a total of N service cards mounted in one of two service multiplexers connected through a transmission cable (where N is a natural number equal to or larger than two) in accordance with time slots previously assigned thereto to multiplex the data into the predetermined frame for transmission to the other service multiplexer connected through the transmission cable; and
distributing data received from the other one of said two service multiplexers into the respective time slots previously assigned thereto to transmit the data to said N service cards mounted in said one service multiplexer.

13. A service multiplexing method for multiplexing data from a plurality of client devices conforming to different data protocols into a predetermined frame for transmission, and for demultiplexing transmitted signals multiplexed in the predetermined frame to said client devices associated therewith, said method comprising the steps of:
selecting data from a total of N service cards mounted in one of a plurality of service multiplexers connected through transmission cables (where N is a natural number equal to or larger than two) in accordance with time slots previously assigned thereto to multiplex the data into M-1 data streams (where M is a natural number equal to or larger than two) for transmission to other M-1 service multiplexers connected through the transmission cables; and
distributing M-1 data streams received from the remaining M-1 service multiplexers respectively connected through the transmission cables into the respective time slots previously assigned thereto to transmit the data to said N service cards, respectively.

14. A service multiplexing method for multiplexing data from a plurality of client devices conforming to different data protocols into a predetermined frame for transmission, and for demultiplexing transmitted signals multiplexed in the predetermined frame to said client devices associated therewith, said method comprising the steps of:
selecting data from a total of N of service cards and a frame multiplex/demultiplex card mounted in one of a plurality of service multiplexers connected through transmission cables (where N is a natural number equal to or larger than two) in accordance with time slots previously assigned thereto to multiplex the data into M-1 data streams (where M is a natural number equal to or larger than two) for transmission to other M-1 service multiplexers connected through the transmission cables; and
distributing M-1 data streams received from the remaining M-1 service multiplexers respectively connected through the transmission cables into the respective time slots previously assigned thereto to transmit the data to N of said service cards and said frame multiplex/demultiplex card, respectively.

15. The service multiplexing method according to claim 11, wherein said predetermined frame is an SDH frame.

16. The service multiplexing method according to claim 11, wherein said frame multiplex/demultiplex card is an OC-48 multiplex/demultiplex card.
